(19) United States
(12) Patent Application Publication
(10) Pub. No.: US 2022/0171067 A1
(43) Pub. Date: Jun. 2, 2022

(54) HYBRID THREE-DIMENSIONAL SENSING SYSTEM

(71) Applicant: Himax Technologies Limited, Tainan City (TW)

(72) Inventors: Hsueh-Tsung Lu, Tainan City (TW); Ching-Wen Wang, Tainan City (TW); Cheng-Che Tsai, Tainan City (TW); Wu-Feng Chen, Tainan City (TW)

(21) Appl. No.: 17/107,656

(22) Filed: Nov. 30, 2020

(51) Int. Cl. G01S 17/894; G01S 7/4865

(52) U.S. Cl. CPC G01S 17/894; H04N 13/271; G01S 7/4865

(57) ABSTRACT

A hybrid three-dimensional (3D) sensing system includes a structured-light (SL) projector that generates an emitted light with a predetermined light pattern; a time-of-flight (ToF) sensor that generates a ToF signal according to a reflected light from a surface of an object incident by the emitted light; a ToF depth processing device that generates a ToF depth image according to the ToF signal; a lookup table (LUT) that gives a gray level for each index value of a sum of accumulated charges of the ToF signal; and an SL depth processing device that generates an SL depth image according to the ToF signal; and a depth weighting device that generates a weighted depth image according to the ToF depth image and the SL depth image.

### BACKGROUND OF THE INVENTION

### 1. Field of the Invention

The present invention generally relates to three-dimensional (3D) sensing, and more particularly to a hybrid 3D sensing system and method.

### 2. Description of Related Art

Computer vision is a technical field that deals with how computers can gain understanding from digital images or videos. Three-dimensional (3D) scanning or sensing is one of disciplines adaptable to computer vision to analyze a real-world object or environment to collect data on shape and appearance of the object to be analyzed. The 3D scanning or sensing can be based on many different technologies, each with its own advantages and limitations.

Structured-light scanning is a 3D scanning scheme that projects a pattern of light onto a scene. The deformation of the pattern is captured by a camera, and then processed, for example, by triangulation, to reconstruct a three-dimensional or depth map of the objects in the scene. Although the structured-light scanning can effectively measure the 3D shape of an object, it suffers depth errors at object edges of the image and in long-range applications.

A time-of-flight (ToF) is another 3D scanning scheme that employs time-of-flight techniques to resolve distance between the system and the object for each point of the image, by measuring the round trip time of an artificial light signal provided by a light source such as laser or light-emitting diode. Contrary to the structured-light scanning, the time-of-flight scheme has limited capability in near-field applications.

A need has thus arisen to propose a novel scheme for overcoming limitations and disadvantages of conventional 3D scanning or sensing systems.

### SUMMARY OF THE INVENTION

In view of the foregoing, it is an object of the embodiment of the present invention to provide a hybrid three-dimensional (3D) sensing system and method adaptable to wide-range applications.

According to one embodiment, a hybrid three-dimensional (3D) sensing system includes a structured-light (SL) projector, a time-of-flight (ToF) sensor, a ToF depth processing device, a lookup table (LUT), an SL depth processing device and a depth weighting device. The SL projector generates an emitted light with a predetermined light pattern. The ToF sensor generates a ToF signal according to a reflected light from a surface of an object incident by the emitted light. The ToF depth processing device generates a ToF depth image according to the ToF signal. The LUT gives a gray level for each index value of a sum of accumulated charges of the ToF signal. The SL depth processing device generates an SL depth image according to the ToF signal. The depth weighting device generates a weighted depth image according to the ToF depth image and the SL depth image.

According to another embodiment, a hybrid three-dimensional (3D) sensing system includes a structured-light (SL) projector, a time-of-flight (ToF) sensor, a ToF depth processing device, a lookup table (LUT), an SL depth processing device and a confidence device. The SL projector generates an emitted light with a predetermined light pattern. The ToF sensor generates a ToF signal according to a reflected light from a surface of an object incident by the emitted light. The ToF depth processing device generates ToF depth data according to the ToF signal. The LUT gives a gray level for each index value of a sum of accumulated charges of the ToF signal. The SL depth processing device generates SL depth data according to the ToF signal. The confidence device determines a confidence level, according to which one of the ToF depth processing device and the SL depth processing device is activated, thereby generating a hybrid depth image.

### BRIEF DESCRIPTION OF THE DRAWINGS

FIG. 1 shows a block diagram illustrating a hybrid three-dimensional (3D) sensing system adaptable to measuring a 3D shape of an object according to a first embodiment of the present invention;

FIG. 2 shows exemplary waveforms of the emitted light (from the SL projector) and the ToF signal;

FIG. 3 shows an exemplary lookup table that gives the gray level for each index value of the sum of the accumulated charges;

FIG. 4A shows a block diagram illustrating a hybrid three-dimensional (3D) sensing system adaptable to measuring a 3D shape of an object according to a second embodiment of the present invention;

FIG. 4B shows a flow diagram illustrating a hybrid three-dimensional (3D) sensing method adaptable to measuring a 3D shape of an object according to one embodiment of the present invention; and

FIG. 4C shows a flow diagram illustrating a hybrid three-dimensional (3D) sensing method adaptable to measuring a 3D shape of an object according to a modified embodiment of the present invention.

### DETAILED DESCRIPTION OF THE INVENTION

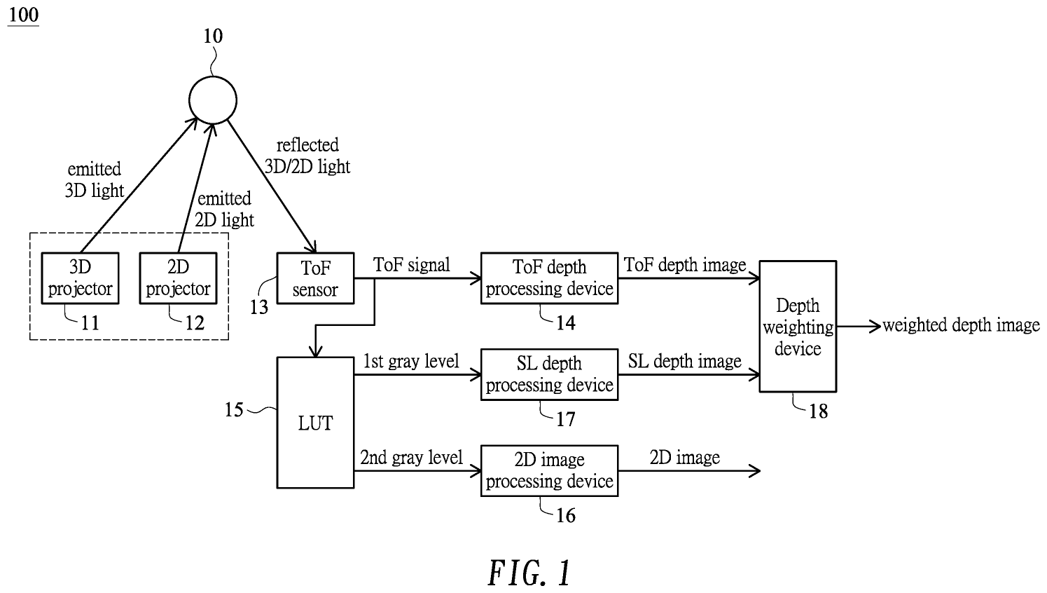

FIG. 1 shows a block diagram illustrating a hybrid three-dimensional (3D) sensing system 100 adaptable to measuring a 3D shape of an object 10 according to a first embodiment of the present invention. The blocks of the hybrid 3D sensing system (“sensing system” hereinafter) 100 may be implemented and executed by hardware (e.g., digital image processor), software or their combinations.

In the embodiment, the sensing system 100 may include a structured-light (SL) projector 101 configured to generate an emitted light with a predetermined light pattern. The SL projector 101 of the embodiment may include a 3D projector 11 configured to generate an emitted 3D light, and a two-dimension (2D) projector 12 configured to generate an emitted 2D light. In one exemplary embodiment, the 3D projector 11 may include a 3D speckle emitter, and the 2D projector 12 may include a 2D flood emitter.

According to one aspect of the embodiment, the sensing system 100 may include a time-of-flight (ToF) sensor 13 adopting a time-of-flight technique to resolve distance (or depth) between the ToF sensor 13 and the object 10 for each point of a captured image, by measuring the round trip time of the emitted light. Specifically, the ToF sensor 13 is coupled to receive a reflected (3D/2D) light from a surface of the object 10 incident by the emitted (3D/2D) light, and is configured to output a ToF signal.

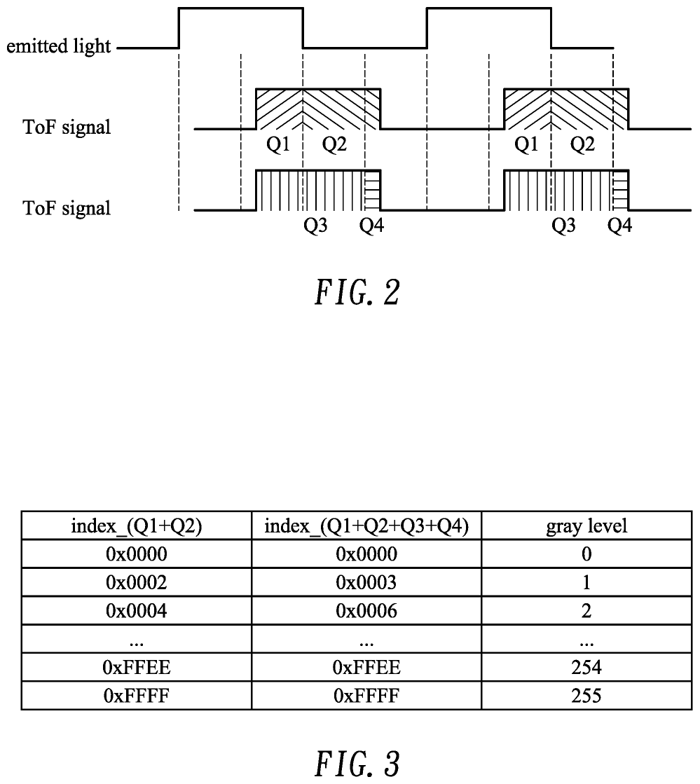

FIG. 2 shows exemplary waveforms of the emitted light (from the SL projector 101) and the ToF signal. In one embodiment, the ToF signal may include accumulated charges Q1 and Q2 in the pixel of the captured image in dual phase mode. In another embodiment, the ToF signal may include accumulated charges Q1, Q2, Q3 and Q4 in quad phase mode.

The sensing system 100 of the embodiment may include a ToF depth processing device 14 coupled to receive the ToF signal and configured to generate a ToF depth image (or depth map) containing ToF depth data of the pixels of the captured image.

According to another aspect of the embodiment, the sensing system 100 may include a lookup table (LUT) 15 (or example, stored in a memory device) that acts as a data transform device and is configured to give a gray level for each index value of a sum of the accumulated charges. FIG. 3 shows an exemplary lookup table 15 that gives the gray level for each index value index_(Q1+Q2) of the sum of the accumulated charges Q1 and Q2, or for each index value index_(Q1+Q2+Q3+Q4) of the sum of the accumulated charges Q1 through Q4. In one exemplary embodiment, the index value index_(Q1+Q2) and the index value index_(Q1+Q2+Q3+Q4) may be expressed as follows:

index_(Q1+Q2)=wt1·Q1+wt2·Q2−wt3·ambient_light

index_(Q1+Q2+Q3+Q4)=WT1·Q1+WT2·Q2+WT3·Q3+WT4·Q4−WT5·ambient_light

where wt1, wt2, wt3, WT1, WT2, WT3, WT4 and WT5 are weights, and ambient_light represents an amount of ambient light.

Specifically, the LUT 15 may generate a first gray level according to the ToF signal when the ToF sensor 13 receives the reflected 3D light. The sensing system 100 of the embodiment may include a structured-light (SL) depth processing device 17 coupled to receive the first gray level and configured to generate an SL depth image containing SL depth data of the pixels of the captured image. It is noted that the LUT 15 is adopted in the embodiment for generating the SL depth image instead of using a structured-light (SL) sensor or receiver as in a conventional SL sensing system. In other words, the ToF sensor 13 of the embodiment is shared for generating both the SL depth image and the ToF depth image.

Alternatively, the LUT 15 may generate a second gray level according to the ToF signal when the ToF sensor 13 receives the reflected 2D light. The sensing system 100 of the embodiment may include a 2D image processing device 16 coupled to receive the second gray level and configured to generate a 2D image containing intensity data of the pixels of the captured image.

According to a further aspect of the embodiment, the sensing system 100 may include a depth weighting device 18 coupled to receive the ToF depth image (from the ToF depth processing device 14) and the SL depth image (from the SL depth processing device 17), and configured to generate a weighted depth image according to the ToF depth image and the SL depth image. The depth of the weighted depth image may be expressed as a weighted sum of the depth of the ToF depth image and the depth of the SL depth image as follows:

weighted_depth_image=w1·ToF_depth_image+w2·SL_depth_image

where w1 and w2 represent first weight and second weight respectively, weighted_depth_image represents the depth of the weighted depth image, ToF_depth_image represents the depth of the ToF depth image, and SL_depth_image represents the depth of the SL depth image.

According to the embodiment as described above, the first weight w1 (associated with the ToF depth image) is increased and the second weight w2 (associated with the SL depth image) is decreased when a distance between the object 10 and the sensing system 100 becomes longer. On the contrary, the first weight w1 (associated with the ToF depth image) is decreased and the second weight w2 (associated with the SL depth image) is increased when a distance between the object 10 and the sensing system 100 becomes shorter. Alternatively speaking, a ratio of the first weight w1 to the second weight w2 is increasing when the distance between the object 10 and the sensing system 100 (or the ToF sensor 13) becomes longer.

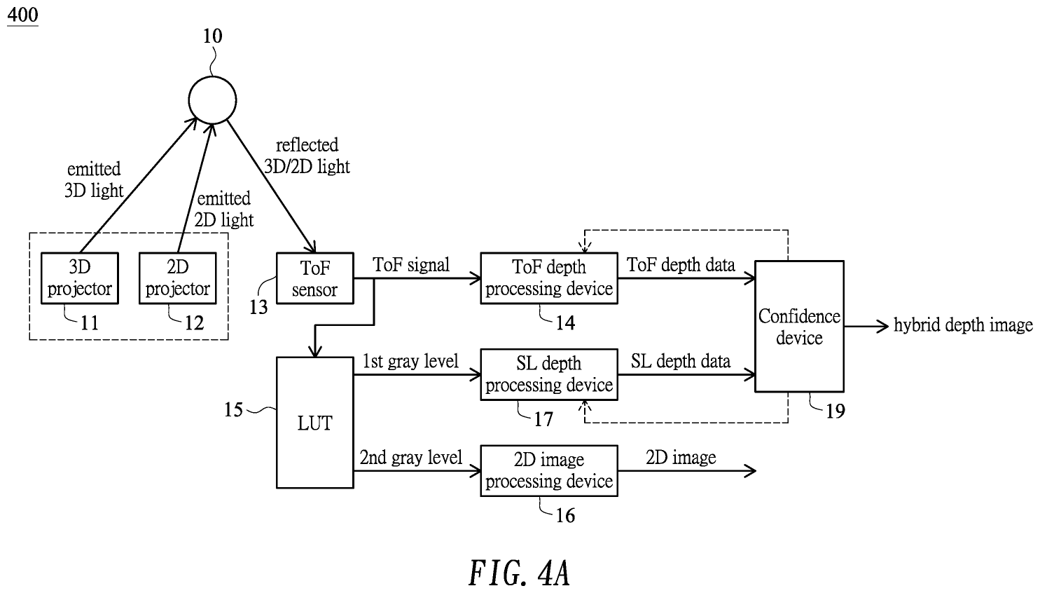

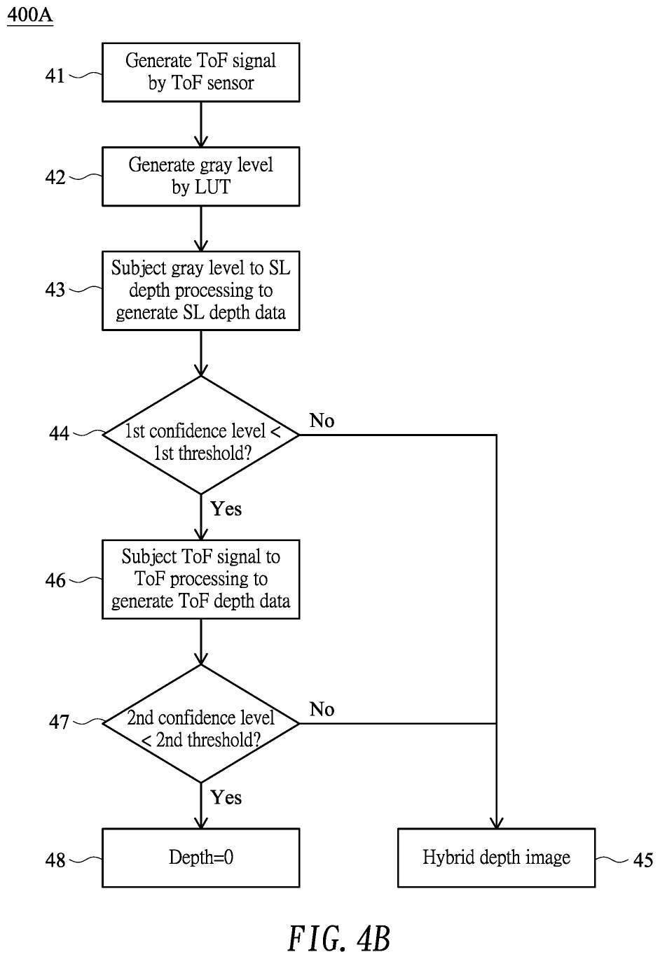

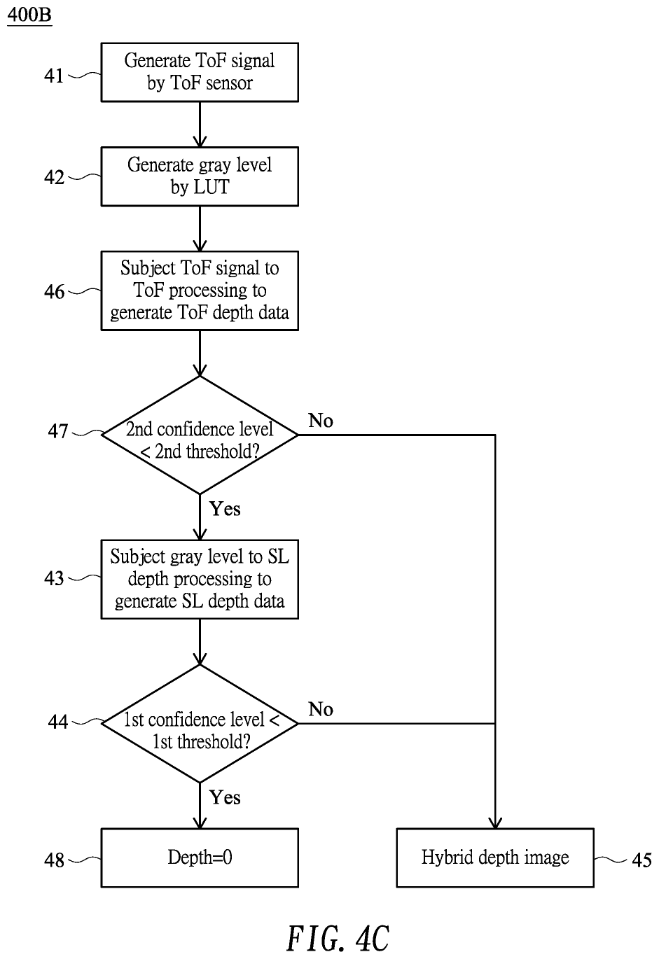

FIG. 4A shows a block diagram illustrating a hybrid three-dimensional (3D) sensing system 400 adaptable to measuring a 3D shape of an object 10 according to a second embodiment of the present invention. The hybrid 3D sensing system (“sensing system” hereinafter) 400 of FIG. 4A is similar to the sensing system 100 of FIG. 1 with the following exceptions. In the embodiment, the sensing system 400 may further include a confidence device 19 configured to control operation of the ToF depth processing device 14 and the SL depth processing device 17.

FIG. 4B shows a flow diagram illustrating a hybrid three-dimensional (3D) sensing method (“sensing method” hereinafter) 400A adaptable to measuring a 3D shape of an object 10 according to one embodiment of the present invention.

Specifically, in step 41, a ToF signal is generated by the ToF sensor 13 according to a reflected (3D/2D) light from a surface of the object 10 incident by the emitted (3D/2D) light. Next, in step 42, a (first/second) gray level is generated by the LUT 15 according to the ToF signal when the ToF sensor 13 receives the reflected (2D/3D) light.

In step 43, the SL depth processing device 17 is activated by the confidence device 19, and the (second) gray level of a current pixel is subject to structured-light (SL) depth processing (by the SL depth processing device 17) to generate SL depth data of the current pixel.

Subsequently, in step 44, a first confidence level of the current pixel is determined by the confidence device 19, and is compared with a predetermined first threshold. If the first confidence level is not less than the first threshold (indicating that the SL depth data is appropriate), the SL depth data of the current pixel is outputted as depth data of a hybrid depth image (step 45). However, if the first confidence level is less than the first threshold (indicating that the SL depth data is inappropriate), the flow goes to step 46, in which the ToF depth processing device 14 is activated by the confidence device 19, and the ToF signal of the current pixel is subject to ToF processing (by the ToF depth processing device 14) to generate ToF depth data of the current pixel.

In step 47, a second confidence level of the current pixel is determined by the confidence device 19, and is compared with a predetermined second threshold. If the second confidence level is not less than the second threshold (indicating that the ToF depth data is appropriate), the ToF depth data of the current pixel is outputted as depth data of the hybrid depth image (step 45). However, if the second confidence level is less than the second threshold (indicating that the ToF depth data is inappropriate), the flow goes to step 48, in which a value zero is assigned to depth data of the current pixel, and is outputted as depth data of the hybrid depth image (step 45). In one exemplary embodiment, the (first/second) confidence level may be a sum of the accumulated charges, for example, Q1, Q2, Q3 and Q4.

FIG. 4C shows a flow diagram illustrating a hybrid three-dimensional (3D) sensing method (“sensing method” hereinafter) 400B adaptable to measuring a 3D shape of an object 10 according to a modified embodiment of the present invention. The sensing method 400B as illustrated in FIG. 4C is similar to the sensing method 400A as illustrated in FIG. 4B with the exceptions as described below.

In the embodiment, the generation of the ToF depth data (step 46) and the comparison of the second confidence level (step 47) are executed before the generation of the SL depth data (step 43) and the comparison of the first confidence level (step 44). Compared to the sensing system 100 of FIG. 1, as only one of the ToF depth processing device 14 and the SL depth processing device 17 is activated at a time in the sensing system 400, computation may be substantially reduced.

Although specific embodiments have been illustrated and described, it will be appreciated by those skilled in the art that various modifications may be made without departing from the scope of the present invention, which is intended to be limited solely by the appended claims.

What is claimed is:

1. A hybrid three-dimensional (3D) sensing system, comprising:
a structured-light (SL) projector that generates an emitted light with a predetermined light pattern;
a time-of-flight (ToF) sensor that generates a ToF signal according to a reflected light from a surface of an object incident by the emitted light;
a ToF depth processing device that generates a ToF depth image according to the ToF signal;
a lookup table (LUT) that gives a gray level for each index value of a sum of accumulated charges of the ToF signal;
an SL depth processing device that generates an SL depth image according to the ToF signal; and
a depth weighting device that generates a weighted depth image according to the ToF depth image and the SL depth image.

2. The system of claim 1, wherein the SL projector comprises:
a 3D projector that generates an emitted 3D light; and
a two-dimension (2D) projector that generates an emitted 2D light.

3. The system of claim 2, wherein the SL depth processing device generates the SL depth image according a first gray level that is generated by the LUT when the ToF sensor receives a reflected 3D light from the surface of the object incident by the emitted 3D light.

4. The system of claim 2, further comprising:
a 2D image processing device that generates a 2D image according a second gray level that is generated by the LUT when the ToF sensor receives a reflected 2D light from the surface of the object incident by the emitted 2D light.

5. The system of claim 1, wherein depth of the weighted depth image is expressed as a weighted sum of depth of the ToF depth image and depth of the SL depth image as follows:
weighted_depth_image=w1·ToF_depth_image+w2·SL_depth_image
where w1 and w2 represent first weight and second weight respectively, weighted_depth_image represents the depth of the weighted depth image, ToF_depth_image represents the depth of the ToF depth image, and SL_depth_image represents the depth of the SL depth image.

6. The system of claim 5, wherein a ratio of the first weight to the second weight is increasing when a distance between the object and the ToF sensor becomes longer.

7. A hybrid three-dimensional (3D) sensing system, comprising:
a structured-light (SL) projector that generates an emitted light with a predetermined light pattern;
a time-of-flight (ToF) sensor that generates a ToF signal according to a reflected light from a surface of an object incident by the emitted light;
a ToF depth processing device that generates ToF depth data according to the ToF signal;
a lookup table (LUT) that gives a gray level for each index value of a sum of accumulated charges of the ToF signal;
an SL depth processing device that generates SL depth data according to the ToF signal; and
a confidence device that determines a confidence level, according to which one of the ToF depth processing device and the SL depth processing device is activated, thereby generating a hybrid depth image.

8. The system of claim 7, wherein the SL projector comprises:
a 3D projector that generates an emitted 3D light; and
a two-dimension (2D) projector that generates an emitted 2D light.

9. The system of claim 8, wherein the SL depth processing device generates the SL depth data according a first gray level that is generated by the LUT when the ToF sensor receives a reflected 3D light from the surface of the object incident by the emitted 3D light.

10. The system of claim 8, further comprising:
a 2D image processing device that generates a 2D image according a second gray level that is generated by the LUT when the ToF sensor receives a reflected 2D light from the surface of the object incident by the emitted 2D light.

11. The system of claim 7, wherein the confidence device performs the following steps:
activating the SL depth processing device to generate the SL depth data of a current pixel;
determining a first confidence level of the current pixel;
outputting the SL depth data as depth data of the hybrid depth image, if the first confidence level is not less than a predetermined first threshold;
activating the ToF depth processing device to generate the ToF depth data of the current pixel, if the first confidence level is less than the predetermined first threshold;
determining a second confidence level of the current pixel after generating the ToF depth data; and
outputting the ToF depth data as depth data of the hybrid depth image, if the second confidence level is not less than a predetermined second threshold.

12. The system of claim 11, wherein the confidence device further performs the following step:
outputting a value zero as depth data of the hybrid depth image, if the second confidence level is less than the predetermined second threshold.

13. The system of claim 7, wherein the confidence device performs the following steps:
activating the ToF depth processing device to generate the ToF depth data of a current pixel;
determining a second confidence level of the current pixel;
outputting the ToF depth data as depth data of the hybrid depth image, if the second confidence level is not less than a predetermined second threshold;
activating the SL depth processing device to generate the SL depth data of the current pixel, if the second confidence level is less than the predetermined second threshold;
determining a first confidence level of the current pixel after generating the SL depth data; and
outputting the SL depth data as depth data of the hybrid depth image, if the first confidence level is not less than a predetermined first threshold.

14. The system of claim 13, wherein the confidence device further performs the following step:
outputting a value zero as depth data of the hybrid depth image, if the first confidence level is less than the predetermined first threshold.
